(19) United States
(12) Patent Application Publication
(10) Pub. No.: US 2006/0184609 A1
(43) Pub. Date: Aug. 17, 2006

(54) Simplified scheme of rich content messaging from PC to mobile devices

(76) Inventor: Li Deng, San Jose, CA (US)

Correspondence Address: Li Deng, 1047 S. Blaney Ave, San Jose, CA, 95129, US

(21) Appl. No.: 11/058,933

(22) Filed: Feb. 16, 2005

(51) Int. Cl. G06F 15/16

(52) U.S. Cl. 709/203

(57) ABSTRACT

A method, apparatus, client and server are directed at providing a simplified scheme to deliver rich content messages that include text, audio, video, and images from desktop computing devices to multimedia capable phones. A web form is provided for users to specify rich content elements such as text, audio, video, and images either from their local desktop computing device or from rich content store on a network. Also provided in the form are input fields for users to enter device numbers and the service providers for recipients. Upon submitting the form, rich content elements are uploaded and stored on the server. A WAP page that contains the links to all the rich content elements is generated dynamically and stored on the server. The server sends a notification message with an embedded link to the specified mobile devices. The link, such as a URL, a script, an executable, a program, and the like, pointing to the WAP page, can be invoked from mobile devices. When the link is invoked on the mobile device, it sends a request to the server for the rich content WAP page. Upon receiving the request from the mobile device, the server collects the information about the mobile device; locates and loads the rich content WAP page; converts the rich content elements to the formats supported by the mobile device; optimizes the WAP page for display on the mobile device; delivers the optimized rich content WAP page to the mobile device. The rich content WAP page can be viewed, downloaded, saved, and played on the mobile device. The scheme of the present invention can also be implemented to deliver rich content messages to multiple mobile devices.

### FIELD OF THE INVENTION

The present invention relates generally to wireless mobile devices with multimedia and wireless internet capabilities, and more particularly but not exclusively to providing a simplified scheme to deliver rich content messages that include texts, audio, video, and images from desktop computing devices to multimedia capable wireless phones.

### BACKGROUND OF THE INVENTION

In today's society, mobile devices are becoming increasingly more powerful. The greatest manifestation is the glue between unwired universes to the Internet domain and the advent of wireless multimedia and wireless internet capabilities. The newest versions of mobile wireless devices are capable of displaying high quality color photos, playing mp3, mp4 and other advanced audio clips, and playing back video clips. Those advanced devices are prime candidates for receiving personalized rich content messages.

Mobile phone network infrastructures provide standard ways to deliver multimedia messages. Multimedia Messaging Service (MMS) is used for delivery of rich messaging content (e.g. SMIL, pictures, text combined with images and/or sounds). To send an MMS Message to an end user, an application will have to leverage the MM7 protocol to post a message to Multimedia Messaging Services Center (MMSC). The MMSC is usually run by mobile carriers. To receive the MMS message, mobile devices have to have MMS capabilities with MMS service enabled and activated with the carriers.

Currently, a lot of handsets out there are not MMS capable. Even for users with MMS capable phones, sending and receiving rich content messages using MMS protocol is still expensive. The potential of abundant PC based rich content is virtually untapped for rich content delivery services of application to phone. The present invention aims at providing a simplified scheme for enabling the delivery of high quality rich content from PC to mobile devices with multimedia capacity. By taking advantages of wide availability of SMS and WAP services on mobile devices, the system and method of the present invention offers a complimentary scheme that greatly broadens the reaches of delivering rich content messages to mobile devices. The present invention will make it possible for users to send rich content messages to SMS and WAP services enabled mobile devices. The present invention in conjunction with MMS service will make rich content delivery to mass mobile devices a reality.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates a logical flow diagram generally showing one embodiment of a simplified scheme to deliver rich content messages that include text, audio, video, and images from desktop computing devices to multimedia capable phones.

FIG. 4 illustrates one embodiment of logical components and data flow for practicing the invention, in accordance with FIG. 3.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will filly convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, un recited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed towards a client, server, and a method providing a simplified scheme to deliver rich content messages that include text, audio, video, and images from desktop computing devices to multimedia capable phones. A web form is provided for user to specify the rich content elements or the locations of the rich content elements. The rich content may be located either on user's desktop computing devices or in a rich content store on a network server database. If the rich content resides at user's desktop computing device, the path or locations of rich content on user's desktop computing device are entered by user in the web form. If the rich content elements are located on a server store, a browse and/or search function may be provided for users to select the desired content. The rich content elements can be in a variety of different formats. For each rich content element, the mobile user may enter a brief description in the web form. User must specify the mobile device number for each recipient. In one embodiment, mobile device number is the mobile phone number. The current invention will deliver a notification message to the specified mobile device numbers. User has the option to enter the carrier info of the mobile device. If the carrier info is not entered, the carrier info will be inferred from the mobile device number by querying a carrier-device database. The current invention may be integrated with address book application. Users may also select one or multiple recipients from their personal address books. Each entry of address book contains at least one piece of info: mobile device number. For each new recipient entered, users have the option to save the entry into their personal address book. User may provide additional information such as the instructions on how the rich content elements should be arranged or the layout of the rich content elements in the web form.

Upon successful submission of the web form, text and rich content components will be uploaded to the server. The uploaded text and rich content components will then be saved on the server. A WAP page will be dynamically generated according to user instructions and stored on the server. For each dynamically generated rich content WAP page, a unique id is generated using any of a variety of mechanisms, including a counter, a MD5 hash, and the like. There is one to one relationship between a unique id and a rich content WAP page. The server may also associate the mobile device numbers with the unique id of the rich content WAP page. The association between the mobile device number and the unique id may be stored on the server. The association may be used later to authenticate the recipient when the rich content WAP page is retrieved. The unique id is sent as part of the notification message to the targeted mobile devices. The unique id is used later to retrieve the rich content WAP page.

The text will be displayed in the WAP page. The description user entered will be put next to each rich content component. Each image will also be displayed in the WAP page. A preview link may be assigned to each audio or video component. For audio or video component, invoking the preview link will play the audio/video clip. A download link may also be assigned to each rich content element for users to download individual element to mobile device.

A notification message, such as an SMS message and the like will be sent to the targeted mobile devices. The notification message may embed a link, such as a Uniform Resource Locator (URL), a script, an executable, a program, and the like, that enables access to the WAP page on the server. The unique id of the WAP page is wrapped in the link embedded in the SMS message. Upon invoking the link or the action embedded in the message, mobile device sends a request to the web server.

Upon receiving the request from the mobile device, the server collects the information about the mobile device via user agent profile and HTTP headers or the likes on the fly. The server also gets the unique id of a rich content WAP as part of the request from the mobile device. In one embodiment where the recipient mobile device may need to be authenticated, the mobile user will be asked to enter the device number at the time of retrieving the rich content WAP page. Once the device number is received by the server, the server will validate the device number against the saved association between unique id and the device numbers. If the device is authenticated, the WAP page will be delivered to the mobile device. Otherwise, the request will be rejected.

More information about the particular mobile device will be queried from a mobile device database. This information include, but not limited to, mobile device model, carrier information, the supported rich content formats, the display dimensions etc. The server then converts all the rich content elements to the formats supported by the mobile device if needed. The server further optimizes the WAP page for display on the mobile device. This process may require the resizing of the image or video elements. The server will deliver the optimized WAP page to the mobile device as requested.

Upon receiving the WAP page on mobile device, the mobile user can read the rich content message. The user also has the option to preview, download and save the audio, video, and images embedded in the rich content message.

In one embodiment, the present invention may provide a link for sender to preview his rich content message on PC or on a mobile device simulator on PC. The sender may also have an option to CC or BCC his rich content message to his message account, which could be his email address, mobile device, IM address, and the like.

In another embodiment, the present invention offers a way to send rich content message to a group of recipients. In this case, multiple mobile device numbers have to be specified by the sender. The same notification message with an embedded link will be sent to the multiple mobile devices associated with the specified mobile device numbers.

Illustrative Operating Environment

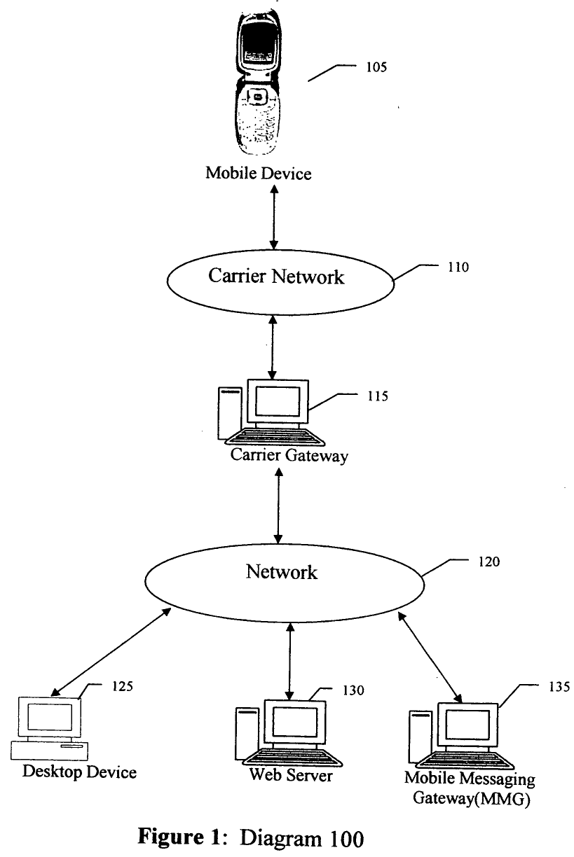

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, diagram100 includes mobile device 105, carrier network 110, carrier gateway 115, network 120, Mobile Messaging Gateway (MMG) 135, Web Server 130, and desktop computing device 125. Carrier network 110 is in communication with mobile device 105 and Carrier Gateway 115. Network 120 is in communication with and enables communication between carrier gateway 115, MMG 135, Web Server 130, and desktop computing device 125.

Generally, mobile device 105 may include virtually any portable computing device capable of connecting to another computing device to send and receive a message. Mobile device 105 may also include other devices, such as Personal Digital Assistants (PDAs), microprocessor-based or programmable consumer electronics, wearable computers, and the like. As such, mobile devices typically range widely in terms of capabilities and features. For example, a web-enabled mobile device may have a touch sensitive screen, a stylus, and several lines of color LCD display in which both text and graphics may be displayed. Moreover, the web-enabled mobile device may include a mobile browser application enabled to receive and to send wireless application protocol messages (WAP), and the like. In one embodiment, the mobile browser application is enabled to employ WAP to fetch and display mobile markup languages such as Handheld Device Markup Language (HDML), Wireless Markup Language (WML), WMLScript, XHTML Mobile Profile, and the like.

Mobile device 105 may include a keyboard, mouse, speakers, a microphone, and an area on which to display information. Mobile device 105 may further include low-end devices that may have limited storage memory, reduced application sets, low bandwidth for transmission of a communication, and the like.

Mobile device 105 may provide a message, network packet, and the like, that includes a device identifier, such as a Mobile Identification Number (MIN). MINs are provided with each WAP request and uniquely identify each handset. Mobile device 105 may further provide a device number in addition to the device identifier. In one embodiment, mobile device 105 includes a device identification component configured to provide the MIN, phone number, and the like.

Mobile device 105 may be configured to receive a message, such as through a Short Message Service (SMS), Multimedia Message Service (MMS), and the like, from the other computing device, such as MMG 135, and the like. In one embodiment, the message includes a link, such as a URL, script, executable, program, and the like. Mobile device 105 may be further configured to employ the link to request access to another piece of info, such as from MMG 135, and the like. In one embodiment, the other info is a rich content WAP page. Multimedia, and virtually any other content type, and the like, may be accessible through the included URL, script, executable, program, and the like. For example, the content may include, but not be limited to, a document that contains multiple audio files, video files, graphics files and the like..

Mobile device 105 may further include a client application, and the like, that is configured to manage the actions described above for mobile device 105.

Carrier network 110 is configured to couple mobile device 105 and its components with carrier gateway 115. Carrier network 110 may include any of a variety of wireless sub-networks that may further overlay stand-alone ad-hoc networks, and the like, to provide an infrastructure-oriented connection for mobile device 105. Such sub-networks may include mesh networks, Wireless LAN (WLAN) networks, cellular networks, and the like.

Carrier network 110 may further include an autonomous system of terminals, gateways, routers, and the like connected by wireless radio links, and the like. These connectors may be configured to move freely and randomly and organize themselves arbitrarily, such that the topology of carrier network 110 may change rapidly.

Carrier network 110 may further employ a plurality of access technologies including, but not limited to, 2nd (2G), 2.5 (2.5G), 3rd (3G) generation radio access for cellular systems, WLAN, Wireless Router (WR) mesh, and the like. Access technologies such as 2G, 2.5G, 3G, and future access networks may enable wide area coverage for mobile devices, such as mobile device 105 with various degrees of mobility. For example, carrier network 110 may enable a radio connection through a radio network access such as Global System for Mobil communication (GSM), General Packet Radio Services (GPRS), Enhanced Data GSM Environment (EDGE), Code Division Multiple Access (CDMA), Code Division Multiple Access 2000(CDMA 2000), Wideband Code Division Multiple Access (WCDMA), and the like. In essence, carrier network 110 may include virtually any wireless communication mechanism by which information may travel between mobile device 105 and carrier gateway 115.

Carrier gateway 115 may include any computing device capable of connecting with mobile device 105 to enable communications with another computing device, such as MMG 135, Web Server 130, PC desktop 125, another mobile device (not shown), and the like. Such devices that may operate as carrier gateway 115 include, but are not limited to, personal computers, desktop computers, multiprocessor systems, microprocessor-based or programmable consumer electronics, network PCs, servers, and the like.

Carrier gateway 115 typically includes a carrier level service provider's computing device, and related infrastructure. Carrier gateway 115 may be configured to receive a network packet, and the like, from mobile device 105. The network packet, and the like, may include information associated with mobile device 105, such as a device identifier, and the like. The network packet may further include information associated with an end-user of mobile device 105, such as a user account identifier, and the like. Carrier gateway 115 may include additional information in the network packet prior to sending the network packet towards another device, such as MMG 135, Web Server 130, and the like. The additional information may include carrier information including, but not limited to, a carrier gateway grouping, carrier type, carrier identifier, and the like.

Carrier gateway 115 may further receive a network packet from Web Server 130, MMG 135, PC desktop 125, and the like. The received network packet may include an SMS message, a mobile browser readable message, and the like.

Network 120 is configured to couple MMG 135, Web Server 130, PC desktop 125, and the like, with carrier gateway 115. Network 120 is enabled to employ any form of computer readable media for communicating information from one electronic device to another. Also, network 120 can include the Internet in addition to local area networks (LANs), wide area networks (WANs), direct connections, such as through a universal serial bus (USB) port, other forms of computer-readable media, or any combination thereof On an interconnected set of LANs, including those based on differing architectures and protocols, a router acts as a link between LANs, enabling messages to be sent from one to another. In essence, network 120 includes any communication method by which information may travel between carrier gateway 110, MMG 135, Web Server 130, desktop computing device 125, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal.

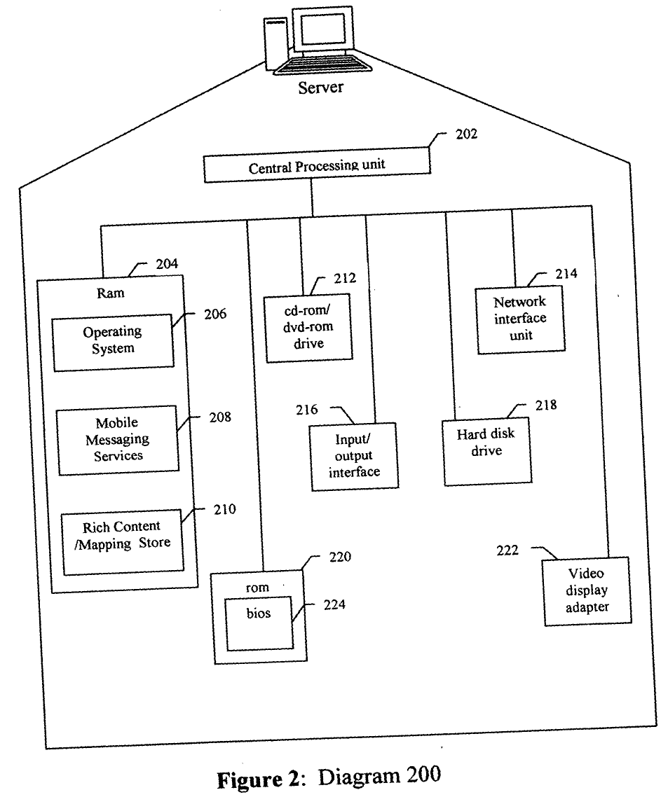

One embodiment of MMG 135 is described in more detail below in conjunction with FIG. 2. Briefly, however, MMG 135 may include any computing device capable of communicating with mobile device 105. Such devices include personal computers, desktop computers, multiprocessor systems, microprocessor-based or programmable consumer electronics, network PCs, servers, and the like.

MMG 135 may be further configured to receive a message notification associated with a message from Web Server 130. In response, MMG 135 may format a short message, such as a SMS message, MMS message, or the like, and send the formatted message towards mobile device 105. In one embodiment, the short message includes a Uniform Resource Locator (URL).

The URL may further include a unique id associated with a rich content WAP page stored on the server side. The unique id may be generated based on any of a variety of mechanisms, including, but not limited to a counter, a MD5 hash, and the like. Web Server 130 may employ a mapping store (not shown) to save the mapping, i.e. the unique id and the location of the rich content WAP page.

Web Server 130 may include any computing device capable of connecting to mobile device 105, MMG 135, and the like, to receive a request, process a request, and send response back to the mobile devices and the like. Such devices include personal computers, desktop computers, multiprocessor systems, microprocessor-based or programmable consumer electronics, network PCs, servers, and the like.

Web Server 130 may be configured to receive the request, for example, from PC desktop 125. Web Server 130 may determine whether the intended recipient of the message is configured to receive the message in a mobile browser readable format.

Web Server 130 may store the rich content elements at a location that may be determined based, in part, on at least one of the user id, file identifier, device number, and the like. In one embodiment, Web Server 130 may store the rich content elements at a server that may be one of a plurality of servers (not shown), or the like.

Although MMG 135 and Web Server 130 are illustrated as distinct computing devices, the present invention is not so limited. For example, the functionality of MMG 135 and Web Server 130 may be associated with a single computing device, or spread across multiple computing devices, without departing from the scope of the invention.

Desktop computing device 125 represents virtually any device enabled to make a network request to another computing device, including but not limited to Web Server 130, MMG 135. Such devices include personal computers, webcam, desktop computers, multiprocessor systems, microprocessor-based or programmable consumer electronics, network PCs, servers, and the like.

Illustrative Server Environment

FIG. 2 shows one embodiment of a server, according to one embodiment of the invention. Server 200 may include many more components than those shown. The components shown, however, are sufficient to disclose an illustrative embodiment for practicing the invention. Server 200 may represent, for example, MMG 135 of FIG. 1.

Server 200 includes processing unit 202, video display adapter 222, and a mass memory, all in communication with each other via a bus. The mass memory generally includes RAM 204, ROM 220, and one or more permanent mass storage devices, such as hard disk drive 212, tape drive, optical drive, and/or floppy disk drive. The mass memory stores operating system 206 for controlling the operation of server 200. Any general-purpose operating system may be employed. Basic input/output system (“BIOS”) 224 is also provided for controlling the low-level operation of server 200. As illustrated in FIG. 2, server 200 also can communicate with the Internet, or some other communications network, such as network 120 in FIG. 1, via network interface unit 214, which is constructed for use with various communication protocols including the TCP/IP protocol. Network interface unit 214 is sometimes known as a transceiver, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM or other optical storage, magnetic cassettes, magnetic tape, magnetic disk storage or other magnetic storage devices, or any other medium which can be used to store the desired information and which can be accessed by a computing device.

The mass memory also stores program code and data. One or more applications are loaded into mass memory and run on operating system 206. Examples of application programs include multimedia uploading programs, multimedia format converting programs, schedulers, database programs, web server programs, mobile markup language processing programs, SMS programs, MMS programs, and so forth. Mass storage may further include applications such as mobile messaging service 208 and rich content mapping store 210.

Mobile messaging service 208 may further receive a mobile message, such as a message notification, indicating that a mobile device is enabled to receive a mobile browser readable message, that a message is available for the mobile device, and the like. Mobile messaging service 208 may also receive Meta information, such as an account id, WAP page identifier, and the like.

Mobile messaging service 208 may further send a short message, such as an SMS message, an MMS message, and the like, to the targeted mobile devices. The short message may include a link, script, executable, program, and the like that enables access to the rich content WAP page. In one embodiment, the link is a URL that includes the unique id that points to the location of rich content WAP page stored on server.

Although illustrated in FIG. 2 as distinct components, mobile messaging service 208 and mapping store 210 may be arranged, combined in any of a variety of ways, without departing from the scope of the present invention. Moreover, messaging service 208 and mapping store 210 may reside in one or more computing devices, substantially similar to server 200.

Server 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server 200 also includes input/output interface 216 for communicating with external devices, such as a mouse, keyboard, scanner, or other input devices not shown in FIG. 2. Likewise, server 200 may further include additional mass storage facilities such as CD-ROM/DVD-ROM drive 212 and hard disk drive 218. Hard disk drive 218 may be utilized to store, among other things, application programs, databases, rich content elements, rich content WAP pages, and the like.

Generalized Operation

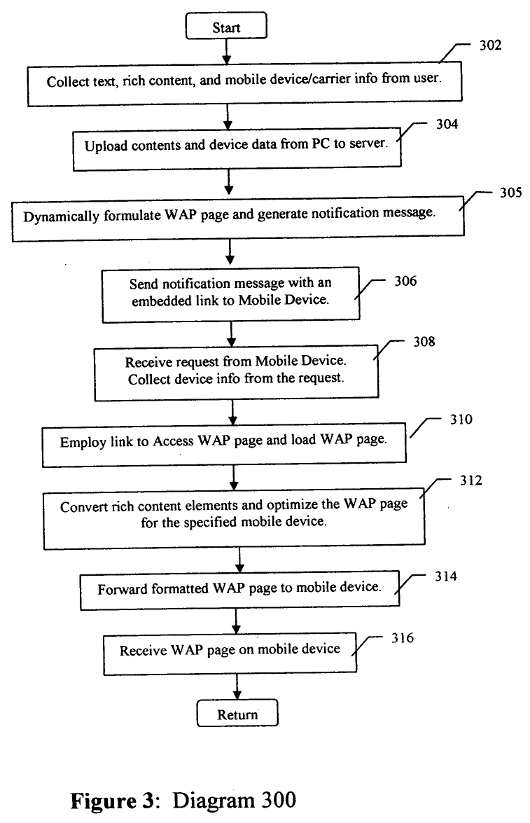

The operation of certain aspects of the present invention will now be described with respect to FIG. 3. FIG. 3 is a flow diagram generally showing one embodiment of a simplified scheme to deliver rich content messages that include texts, audio, video, and images from desktop computing devices to multimedia capable phones.

The process 300 begins, after a start block, at block 302, where users enter rich content messages and info about the targeted mobile devices. The user input includes, but not limited to, texts and rich content elements either from user's local PC or from a networked server store via browse or search; the description of rich content elements; the mobile device numbers, and carrier info about the mobile devices that will receive the rich content message. An option may be provided to users to arrange the layout of the WAP page.

For ease of understanding, the process 300 employs an SMS message as the notification with an embedded URL as the message link to the dynamically formatted WAP page. However, the present invention is not so limited and virtually any messaging vehicle may be employed to deliver the notification. Additionally, virtually any message link may be employed to enable access to the rich content WAP page, including a URL, a script, an executable, a program, and the like.

Processing continues to block 304 where the texts and rich content elements of different formats are uploaded into server and stored. A device number in conjunction with carrier info associated with the mobile device for each recipient is also forwarded to the server. The device number may be a phone number, and the like. Processing continues to block 305 where a WAP page is dynamically formulated according to user instruction using the texts and the rich content elements provided by the user. For each dynamically generated rich content WAP page, a unique id is generated using any of a variety of mechanisms, including a counter, a MD5 hash, and the like. The unique id is mapped via a mapping mechanism to the rich content WAP page. The unique id is sent as part of the SMS message to the targeted mobile devices and is used later to retrieve the rich content WAP page.

The text is the element that is completely displayed in the WAP page. The user specified description is displayed next to each rich content element. Each image is included in the WAP page. A preview link will be assigned to each audio and video element. For audio or video component, invoking the preview link on mobile device will play the audio or video clip. A download link will also be assigned to each rich content element. Processing continues to block 306 where a SMS notification message is generated. The notification message contains a link that points to the rich content WAP page. The notification message is sent by the server to all the mobile devices associated with the mobile device numbers. In one embodiment, a URL is included in the notification message.

Processing flows next to block 308, where the mobile device requests the WAP page by responding to the link within the notification message. The server receives the request from the mobile device. The server also collects device information from the request on the fly. The server further queries more device information from the mobile device database to find out about the device capabilities and the rich content formats supported by the device. The mobile device identifier may also be sent to the server along with an HTTP request from the mobile device.

Processing next continues to block 310 as in one embodiment, where server uses the unique id sent as part of the URL to access the WAP page pointed to by the link contained in the notification message. The WAP page is loaded into memory. The processing then flows to processing block 312, where the server converts the rich content elements to formats supported by the requesting mobile device. It may further optimize the display on the specified mobile device.

At block 314, the optimized WAP page is delivered to the targeted mobile device. At block 316, the rich content WAP page is received by the mobile device. The video, audio, and images in the message can be readily viewed, downloaded, and played on mobile device.

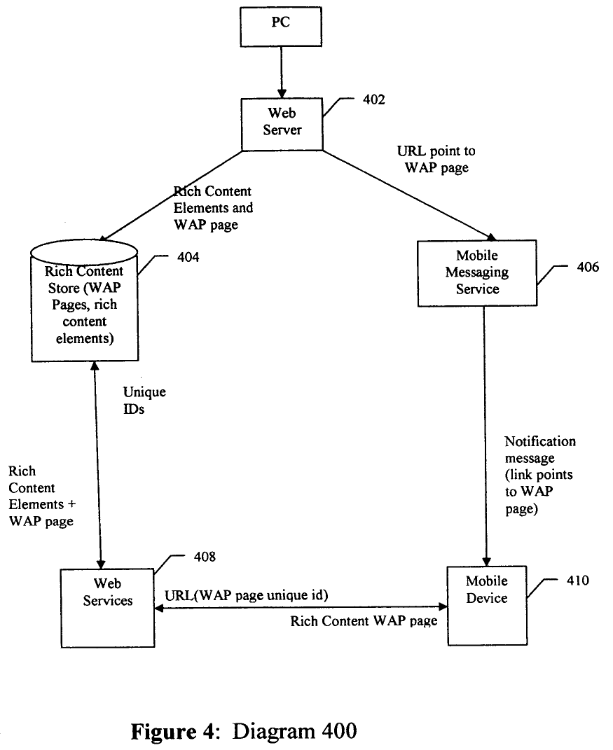

FIG. 4 illustrates logical components and data flow that may be enabled for the processes specified in FIG. 3. Process 400 may be implemented within MMG 135 of FIG. 1. As shown in the figure, the flow 400 includes web server 402, rich content Store 404, mobile device 410, web service 408, and Mobile Messaging Service 406. Mobile messaging service 406 is in communication with Web Server 402 and mobile device 410. Web service 408 is in communication with mobile device 410 and rich content store 404.

Web services 408 may operate as a component within Web Server 402, or operate within another computing device, or as a combination of MMG 135 and the other computing device.

Mobile device 410 may communicate with mobile messaging service 406 to receive the SMS message with an embedded link. Mobile device 410 may also communicate with Web Services 408 to fetch the rich content WAP page.

Web Server 402 handles all requests from PCs and from mobile devices. In one embodiment, Web Server 402 is enabled to display a web form upon an http request, and then process the form to upload and store the rich content elements, to collect the info about mobile device. The uploaded rich content components are saved temporally into the rich content store 404.

Mobile messaging service 406 generates and delivers notification message to mobile devices. It receives the notification request from Web Server 402, along with the unique id for the rich content WAP page and the like. Mobile messaging service 406 then generates a short message, such as an SMS message, and the like, that includes a link, such as a URL. The short message with an embedded link, and the like, is sent to mobile device 410.

Mobile device 410 sends a request link to web service 408, where the request link includes at least the link pointing to the stored rich content WAP page. Mobile device 410 may also send its device identifier to web service 408.

Web service 408 receives the request for the rich content WAP page from the mobile device. Web service 408 employs the associated information, including the link, device number, and the like, to access the rich content WAP page stored in the rich content store 404. Web service 408 may further optimize the rich content WAP page. The rich content elements embedded into the WAP page can be readily viewed, previewed, saved, and played on the mobile device. Web service 408 then send the optimized rich content WAP page to mobile device 410.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A client, server, and method providing a simplified scheme to deliver rich content messages that include texts, audio, video, and images from desktop computing devices to multimedia capable phones, comprising:
Uploading rich content components such as texts, audio, video, and images from user's desktop computing device to server;
Browsing and searching the rich content database to select rich content items on a network.
Collecting targeted mobile device info such as phone number and/or carrier information from sender;
Store rich contend components in rich content store on server;
Arranging and laying out texts, audio, video, and images to generate a WAP page so that it can be saved, viewed, downloaded and played on the mobile device with a micro browser;
Generating a unique id for each dynamically generated rich content WAP page using any of a variety of mechanisms, including a counter, a MD5 hash;
Mapping the unique id to the rich content WAP page;
Store the generated WAP page on server;
Sending a notification message to the mobile device, wherein the notification message includes a link to the rich content WAP page;
Employing the link to access rich content WAP page;
Colleting device info on the fly from HTTP header and user agent profiles;
Converting the rich content elements to formats supported by the requesting mobile device.
Optimizing the WAP page for display on the particular mobile device;
Delivering the WAP page to the mobile device for viewing, saving, and downloading.

2. The method of claim 1, wherein arranging and laying out rich content elements dynamically into a WAP page that can be accessed through a micro browser.

3. The method of claim 2, wherein all the rich content components in the WAP page are constructed to be viewed, previewed, downloaded, saved, and played back on a mobile device.

4. The method of claim 1, wherein generating a link that can be used to invoke a request from mobile device to retrieve the WAP page that contains all the rich content elements.

5. The method of claim 4, wherein the link further comprises of a Uniform Resource Locator (URL), a script, an executable, program, and the like.

6. The method of claim 1, wherein sending the notification message to mobile device further comprises:
Associating the link with the WAP page that contains all the rich content elements uploaded and stored on the server;
Associating links with all the rich content elements within the WAP page;
Sending the notification message including the associated link to the mobile device, wherein the link is employable to locate the rich content WAP page and all the rich content elements on the server.

7. The method of claim 1, wherein offering options to specify multiple recipients of the rich content message and delivering notifications to a group of devices at the same time.

8. The method of claim 1, wherein collecting the information about the mobile device from the request of the mobile device on the fly.

9. The method of claim 8, where device info collected on the fly via user agent profile and HTTP headers, etc.

10. The method of claim 8, wherein using the info collected about a device on the fly through requests to query a device database to find out about the capabilities and formats supported by the device, and the like.

11. The method of claim 1, wherein converting rich content elements into formats that are supported by the mobile device so that they can be saved, viewed, previewed, downloaded and played on the mobile device.

12. The method of claim 1, wherein optimizing the WAP page for display on a particular mobile device.

13. The method of claim 1, wherein the uploaded rich content elements are stored in a rich content store.

14. The method of claim 6, wherein the WAP page contains links to rich content elements. Users can use those links to view, preview, download, and save the rich content elements stored in the server.

15. The method of claim 1, wherein uploading the rich content elements to the server further comprises:
Uploading the rich content elements into web server;
Storing the rich content elements at a rich content store;

16. A client adapted for use in a mobile device to receive messages from a server over a network, the client being configured to perform actions, comprising:
Receiving a notification message from the server, wherein the notification message includes a link;
Employing the link to access the rich content WAP page, wherein the rich content WAP page contains links to rich content elements that can be readily saved, previewed, viewed, and played on mobile device.

17. The method of claim 1, wherein the rich content elements are converted to the formats supported by the mobile device identified from the request when the link is invoked from mobile device to retrieve the rich content WAP page.

18. The method of claim 1, wherein the rich content WAP page is optimized according to the mobile device identified from the request when the link is invoked from mobile device to retrieve the rich content WAP page.

19. In addition to claim 1, the simplified scheme may further comprise authenticating the request to retrieve the rich content WAP page using mobile device numbers, wherein the authentication of recipients further comprises
Associating the generated unique id to the mobile device numbers of recipients;
Store the association between the unique id of rich content WAP page and the mobile device number of the recipient.
Prompting user to enter mobile device number at the time of retrieving the rich content WAP page;
Validating the mobile device number against the saved device number in the association between the mobile device number and the unique id of rich content WAP page.

20. A server for managing a communication with a mobile device over a network, comprising:
Handling http request from PC;
A transceiver for receiving and sending messages to the mobile device;
Receiving rich content elements and saving them into rich content store;
Generating a rich content WAP page that contains links to all the rich content elements stored in the server;
Generating a unique ID for each rich content WAP page;
Mapping the unique ID to each rich content WAP page;
Delivering a notification message to the mobile device, wherein the notification message includes a link;
Handling http request from the mobile device for the WAP page using the link;
Employing the link to enable access to the rich content WAP page for view, preview and download;
Saving the association between the mobile device number and the unique id of the rich content WAP page for authentication of recipients;
Collecting characteristics of the mobile device from the mobile request.
Querying device database for additional device information.
Converting rich content elements to formats supported by mobile device;
Optimizing the WAP page for display on a particular mobile device;
Delivering the WAP to mobile devices.
